(19) United States
(12) Patent Application Publication
(10) Pub. No.: US 2005/0001743 A1
(43) Pub. Date: Jan. 6, 2005

(54) INFORMATION RETRIEVAL AND DISPLAY DEVICE AND SYSTEM

(76) Inventor: Richard R. Haemerle, Valley Park, MO (US)

Correspondence Address: BLACKWELL SANDERS PEPER MARTIN LLP, 720 OLIVE STREET, SUITE 2400, ST. LOUIS, MO, 63101, US

(21) Appl. No.: 10/604,235

(22) Filed: Jul. 2, 2003

(51) Int. Cl. H04N 7/173; H04N 7/20; H04N 7/16; G08G 1/123

(52) U.S. Cl. 340/988; 340/995.26; 725/62; 725/68

(57) ABSTRACT

The present invention provides a device and method for providing a user with location-specific information. The information provided includes directory services, news services, geographical information, advertisements, and more. The present invention also provides a device for accessing the information conveniently and for storing and sending retrieved information as well as providing a mechanism for acting upon information received such as, for example, dialing a phone number or engaging with a virtual environment.

### BACKGROUND OF INVENTION

The present invention relates generally to a device and method of providing information to a user and, more particularly, to a device and method for providing a user with location-specific information including directory services, advertising and marketing services, and communications services as well as a device that may be used by a third party to locate the user.

The rise of wireless communication over the past decade has been tremendous. Cellular phone use, GPS and other satellite devices, and wireless Internet technology has continued to develop rapidly despite the lack of broad standards. The technology has, in fact, progressed so rapidly that it has, in many instances, become unwieldy. By the end of 2003, international online spending is expected to reach $4 trillion. As online spending grows, more and more businesses and individuals find it necessary to establish an online presence. Of course, as the number of sites on the Internet increases, so too does the difficulty in finding any given web site and/or the requested information or data being searched.

The most commons method currently used for finding a given web site is the Internet search engine. Search engines use various algorithms to return results to a user, and some search engines provide better results than others. Nevertheless, any search engine is liable to return thousands of results for any given search. Browsing through page upon page of Internet web sites in order to find the precise information for which one is searching can be time-consuming and, in many cases, ultimately unsuccessful. Thus, while the amount of information available online is enormous, it is not in a conveniently categorized or indexed form that is readily accessible by a user.

While the phenomenal growth of the Internet has been such that finding specific information can become a chore, it has also provided an amazing potential for the reduction of paper wastes. Telephone directories alone are a major source of solid waste. Though many communities have active telephone book recycling programs, it is estimated that only ⅕ of telephone directories are recycled. The rest, approaching 4 million pounds, are thrown away. A mobile, digital device that is capable of providing directory service would go a long way toward reducing the need for paper phone books.

What is required, therefore, is a self-contained wireless network that incorporates the advantageous aspects of the Internet while at the same time eliminating many, if not all, of the negative aspects of the Internet. The information on the network should be structured such that specific information is easily accessible. It is further required that a mobile device be provided to allow a user to access the self-contained network and retrieve information quickly and easily. It is further desirable that the information that can be retrieved include location-specific information, including telephone directory services from around the world in order to reduce or eliminate reliance on paper phone books.

### SUMMARY OF INVENTION

The present invention provides a device and method for providing location-specific information to a user over a wireless communications network. The information is stored in one or more self-contained databases that provide for easy access to the specific information the user is requesting as well as for targeted advertising. Further, the wireless communications network of the present invention allows for video and audio communication between two users of the network who have the device component of the present invention.

One aspect of the present invention provides a hand-held mobile unit having a display screen, an alphanumeric keypad having numerous pushbutton keys thereon, a video camera mounted in the mobile unit, and an outlet for a hands-free microphone and speaker earpiece. In ordinary use, the user can use the mobile unit to call specific information to the display screen, view targeted advertisements, or communicate via audio and/or video with another user. The information the user may retrieve includes, but is not limited to, directory information, weather information, positional information via the GPS system, and the like. When directory information is provided, the user may use the unit to communicate with a desired business or residence by dialing the appropriate phone number.

Another aspect of the present invention includes a self-contained database and method of providing information to the user. In a preferred embodiment of the present invention, all of the data required for the present invention is stored in a centralized location and updated daily. Any suitable database system may be used, so long as the information is indexed such that a user can easily retrieve precisely the information he or she is seeking. The information is transmitted via a wireless network. Further, the mobile unit is in communication with the GPS satellite system and transmits its location to the central database. The central database can, therefore, provide the user with location-specific information.

Thus, the present invention allows for simple and efficient retrieval and display of information over a self-contained wireless network. The present invention also allows a user to immediately access the desired information without connecting to the Internet and relying on search engines, which generally return a number of useless results in response to any given search request and which require navigation through multiple pages before the sought-after information is retrieved (if it is retrieved at all).

Further, because the layout and design of the present device and network is centrally controlled, the system is standardized such that any user can retrieve needed information quickly and easily. The user is not subject to the quirks of individual programmers, as is the case with the Internet, because the content of the network is controlled from a central location. The usefulness of the present device for the purposes it is designed, therefore, is much greater than the usefulness of the Internet for the same purposes.

Another aspect of the present invention provides a recording device for recording audio or video communications between a user and others or a user and the centralized database, as well as a device that can play back audio or video recordings at the user's request.

In yet another aspect of the present invention, a digital camera device is provided for taking digital photographs. The present device also allows transmission of digital photographs taken with the device over a wireless communications network.

Another aspect of the present invention provides a virtual environment display with which a user can take a virtual tour of a building, business, geographical location, or product suitable for being adapted to a virtual environment.

In still another aspect of the present invention, a travel planning system is provided. Using this system, a user is able to plan and arrange the various aspects of an upcoming travel event.

The present invention also provides an emergency GPS locator for identifying the geographic location of a user in an emergency or other situation.

In another aspect of the present invention, an entertainment directory is provided for providing a user with easily accessible entertainment information.

Also provided in another aspect of the present invention is a news service that allows a user to monitor multiple worldwide news services as well as browse through numerous news outlets available through the service provided in conjunction with the present invention.

Another aspect of the present invention provides a personalized directory that maintains personal favorites and commonly accessed information categorized separately from other information in the centralized database.

### BRIEF DESCRIPTION OF DRAWINGS

FIG. 1 is a schematic illustration of the communication between a mobile embodiment of the device of the present invention, the centralized database of the present invention, the GPS satellite system, and a user's home base.

FIG. 2 is a perspective view of one embodiment of the mobile device of the present invention.

FIG. 3 is a perspective view of one embodiment of the mobile device of the present invention showing the device in the open, partially open, and partially closed positions.

FIG. 4 is a perspective view of one alternative embodiment of the present invention.

FIG. 5 is a schematic representation of the present system, illustrating data flow paths between various components of the system.

### DETAILED DESCRIPTION

Referring now to the Figures, wherein like numerals represent like parts, the numeral 10 refers generally to an information retrieval system constructed in accordance with the teachings of the present invention.

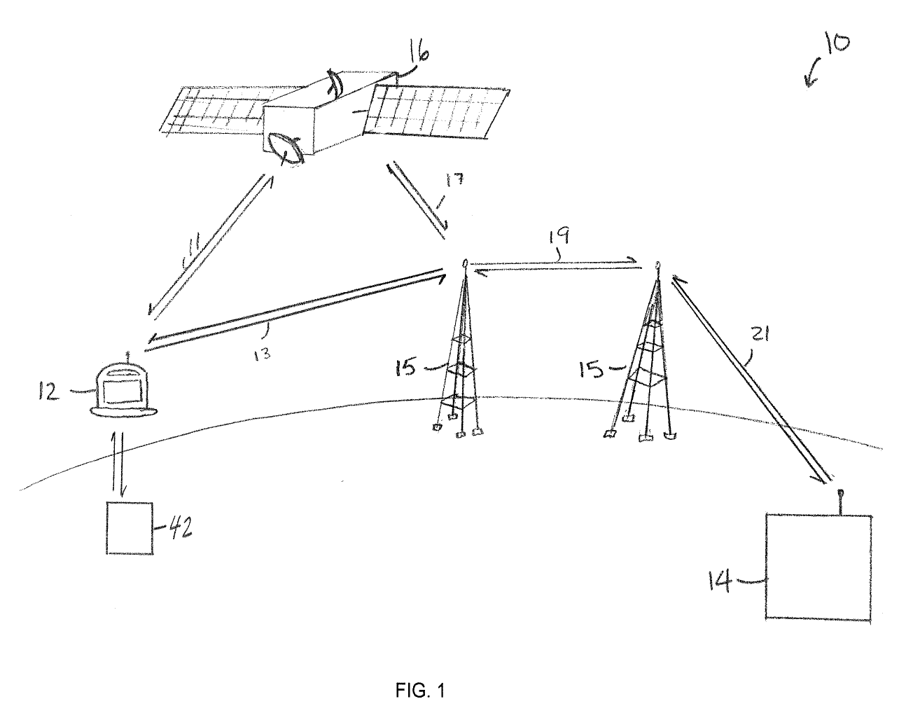

FIG. 1 is a schematic illustration of an information retrieval system 10 constructed in accordance with the teachings of the present invention. The unit 12 is a device capable of transmitting and receiving information and other data and can be either a mobile unit, which is portable and can be carried by a user, or a stationary unit located in a home, office, or elsewhere. The unit 12 is in communication with centralized database 14 and at least one GPS satellite 16. Unit 12 is used by a subscriber of the present system to retrieve information therefrom.

Unit 12 is in the possession of a user while in use and may be located at any geographical location where a network signal is available. Unit 12 is in constant communication with GPS satellite 16 via data path 11 (in actuality, unit 12 is in communication with multiple GPS satellites; one satellite is illustrated in FIG. 1 for purposes of convenience and clarity). Thus, unit 12 is able to constantly supply a user with GPS information, including the user's geographic location if unit 12 is a mobile unit. All non-GPS information able to be retrieved by the user of unit 12 is stored in centralized database 14. For example, centralized database 14 can correlate the information stored therein with GPS information received from unit 12 and then supply the user with time and weather information specific to the user's locale. Alternatively, centralized database 14 can supply the user with time, weather, or other information specific to any chosen locale throughout the world. In the embodiment shown in FIG. 1, centralized database 14 communicates with a network of towers 15 along data path 21. Towers 15, in turn, communicate with one another along data paths 19 and communicate with unit 12 along data path 13. Alternatively, centralized database 14 could communicate with unit 12 via a network of satellites 40, or via a combination of satellites 40 and towers 15. In some situations, centralized database 14 may communicate directly with unit 12. In addition, a plurality of users may communicate with one another directly if each user is in possession of at least one unit 12. This communication may also take place via transmission towers, satellites, or directly from one unit 12 to another unit 12, but need not go through centralized database 14.

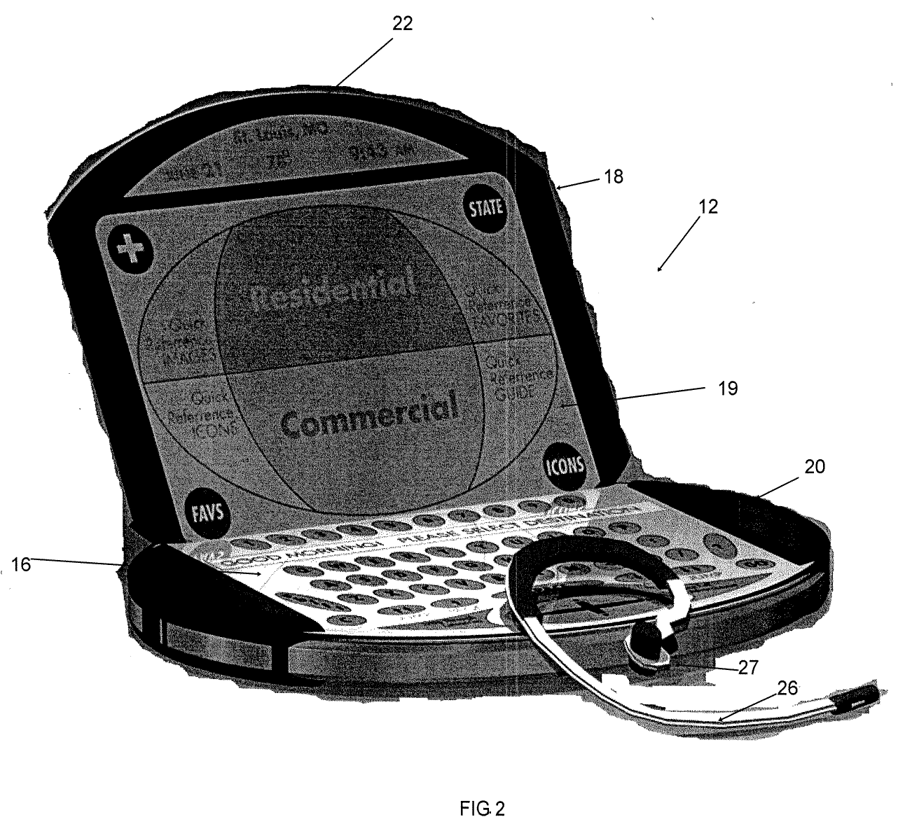

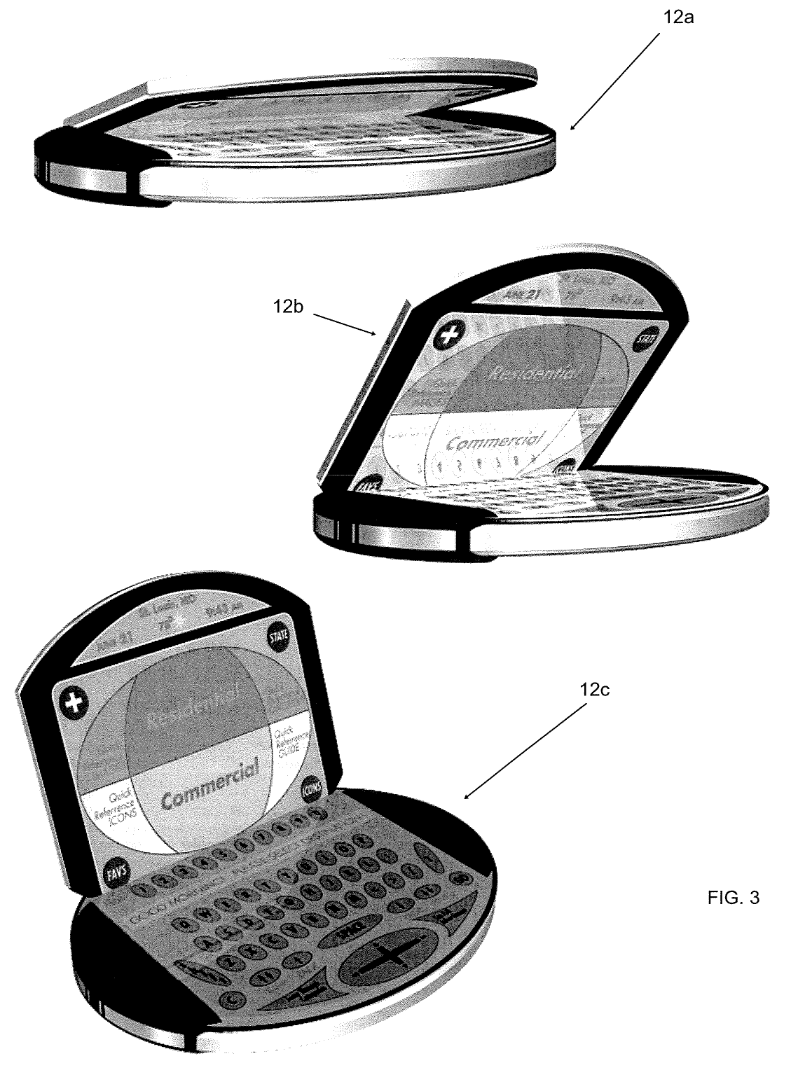

A perspective view of one embodiment of a mobile unit 12 of the present invention is shown in FIG. 2. Mobile unit 12 is divisible into two major components: display portion 18 and interface portion 20. Display portion 18 folds onto interface portion 20 to close mobile unit 12, as best shown in FIG. 3. In FIG. 3, the numeral 12a represents mobile unit 12 as it is beginning to open after being in the closed position. Mobile unit 12 preferably opens in a manner similar to that in which, for example, a laptop computer opens. Numeral 12b represents mobile unit 12 in a substantially open position, while numeral 12c represents mobile unit 12 in a fully open position. Though the embodiment described is one preferred embodiment of mobile unit 12, it is understood and recognized that it is not necessary that mobile unit 12 be capable of closing at all. Various configurations of the device may be utilized without departing from the present invention. Display portion 18 has a screen 19, which is used to display a variety of information, including advertisements, retrieved from centralized database 14 by the user. Screen 19 may be an LCD screen or any other suitable screen. Also shown in FIG. 2 is GPS window 22. GPS window 22 provides the user with his current location as well as a variety of location-specific information such as time, temperature and the like. Alternatively, the same information may be retrieved that is location-specific to any point on the globe.

The other major component of mobile device 12 is interface portion 20. Interface portion 20 contains keypad 16, by which the user enters commands into mobile device 12. Also provided with interface portion 20 is an audio jack (not shown) for attaching earpiece 26 to the device. In an alternative embodiment of the present invention, earpiece 26 may be wireless. Additional components such as USB ports and the like for interfacing, for example, with a desktop computer, can also be provided.

As an alternative or supplement to keypad 16 described above, the present device may be provided with a touch screen and/or stylus by which the user may interface with mobile unit 12 without using a standard keyboard-style keypad. As another alternative, or as a supplement to any of the interface methods described above, voice-recognition technology could be employed to allow hands-free operation of mobile unit 12. Any of the above features may be likewise provided with a stationary unit.

Now there will be detailed some of the various uses and configurations of the device of the present invention. These features are equally applicable to a mobile unit 12 as well as to a stationary unit 12. In one embodiment of the present invention, the user is provided with selectable choices such as “State” or “Government,” “Business” or “Commercial,” and “Residential.” These choices are displayed on screen 19. By selecting one of these broad categories, the user enters a specified subsection of centralized database 14. The device then acts essentially as an automated telephone directory, among other uses, as detailed below. Alternatively, the user may be provided with an option that allows access of worldwide information, rather than narrowing the access to specific categories.

For example, if the user selects “Business” or “Commercial,” the device may display a listing of categories available, such as “Restaurant,” “Automotive Repair,” “Electronics” and the like. Alternatively, the user may choose to go directly to a scrollable alphabetic listing of entries, at which time the user can scroll through the entries much like scrolling through a phonebook. Thus, the present device provides the user with faster access to information than a printed phonebook.

A given business can control the prominence of its advertisement in much the same way as traditional advertising media. That is, advertising packages may be available that allow a business to place an advertisement that is larger or more colorful that the usual directory listing. An advertiser could also include images and/or sound files along with advertisements in order to increase the marketing power of the advertisement.

The present device is able to provide national and even worldwide information, whereas a traditional phonebook provides only local information. In addition, the present device is more ecologically sound than a phonebook in that it does not require the mass consumption of paper that phonebooks increasingly use in each successive printing. Also, the waste generated by old phonebooks is eliminated.

Once the user selects a category in which to search for businesses, directed advertisements may be used to inform the user of the specifics of various businesses in the area. Since the present device has GPS capabilities, the advertisements provided will generally be those of businesses in the immediate area, unless the user selects information from another geographic location. Since the information in centralized database 14 is updated regularly (every day in a preferred embodiment of the present invention) the information provided to the user is not only specific, but timely. For example, the user may be provided with information concerning sales and promotions or with coupons for specific products and/or services.

By entering the “Residential” portion of the database, the user can access the phone number of any “listed” individual in the United States or, conceivably, the world. The operation of the device as it pertains to the residential database is essentially the same as the operation in the commercial database, except that the entries are not grouped by category. Rather, the user can choose the geographical location he wishes to search and then retrieve listings in that area sorted alphabetically by last name. Once the results are received and displayed, the user is able to scroll through the listings using keys in keypad 16. Once the user locates the entry being sought, that entry can be selected and as much specific information as is available in centralized database 14 is displayed on screen 19. Unit 12 is also capable of dialing the chosen telephone number automatically.

In either event, business or residential, the present device is able to dial any number retrieved from the database and the user can communicate with a person on the other end of the line by use of earpiece 26, which includes a speaker/microphone combination. If the person on the other end of the communication also has a device constructed in accordance with the teachings of the present invention, the two users may communicate by video as well as audio through the use of camera 28.

The “State” or “Government” database may function in much the same way as the business database. That is, not only does the government database contain contact information for various State, Federal, or international government agencies, which the user may retrieve and sort alphabetically or by category, it is preferably an outlet for advertisement by governmental entities. For example, a State or Country Board of Tourism may provide location-specific advertisements to inform the user of state parks, monuments, and the like. A user in any given geographical area could easily retrieve information on state parks, monuments, and the like, including the relative locations of various amenities and places of interests such as lakes, campgrounds, trails or other features identified in centralized database 14. Depending on the type of advertisement purchased by the governmental entity, the user may access audio or video clips of attractions in the immediate area, or may be provided with a virtual tour of a location as described further below.

In addition to the core directory services described above, the device of the present invention is able to provide a number of other services as described below.

Wireless Phone

The present device can place or receive calls in much the same manner as a wireless or cellular phone. Using keypad 16, a user can place calls to another number in the same manner in which he would place a call using any mobile phone. Calls may be placed to any functioning telephone number and not just to other devices that are part of the system of the present invention. Once a call is connected, the user can communicate with a person on the other end via earpiece 26. In addition, features such as caller ID, voice mail, and others commonly associated with a cellular phone may be provided. Features such as call waiting can be activated safely when, for example, driving, by toggling earpiece 26 with toggle 27. Alternatively, a speaker and/or microphone (not shown) may be mounted directly within unit 12, thereby eliminating the need for earpiece 26. Unit 12 need not be opened in order to place or receive calls. Further, toggle 27 can be operable to adjust speaker volume and microphone range, so that the user does not need to reach unit 12 in order to perform these actions. Toggle 27 also serves to answer calls, end calls, toggle call waiting, and the like.

Further, in conjunction with the wireless phone aspect of the present invention, the user may be provided with a list of “contacts” stored in the memory of unit 12. The contact information stored may include, for example, names, telephone numbers, pictures, biographical information, business-related information, or any other information the user wishes to enter in association with the contact.

Recording Device

The present device may be provided with memory sufficient to allow recording of audio and/or video communications. The contents of such communications may then be retrieved at a later date. The video communications recorded may be received through camera 28 or may contain the activity being displayed on screen 19 or, in some cases, both. The audio communication being recorded generally includes audio from the user and either centralized database 14 or another individual included in a telephone call or videoconference. The audio portion of the recording includes the audio content transmitted via earpiece 26. This is particularly useful when the user is engaged in a conversation while driving or otherwise occupied and is unable to write in order to make notes of the contents of a conversation. Also, details of business transactions may be recorded by unit 12 for later verification or review.

Digital Camera

Camera 28, provided in a preferred embodiment of the present invention, may also be used to take digital photographs. In addition the photographs taken with camera 28, the present device is able to ‘photograph,’ or perform a screen capture, of the contents of screen 19 at any given time. These photographs can be stored in the device in any of a number of popular image formats, including, tiff, jpeg and gif. The images may also be transmitted via email or USB port to other users or to a desktop or laptop computer. Alternatively, a recorded video or image may be transmitted via a wireless phone network by dialing the recipient's wireless number. This feature of the present invention may be used to conduct a videoconference between two or more users, each having a unit 12. Hearing-impaired individuals may use this feature of the invention to communicate via American Sign Language or via other visual-based methods of communication. A user may even record a message for him or herself to serve as a reminder at a future time.

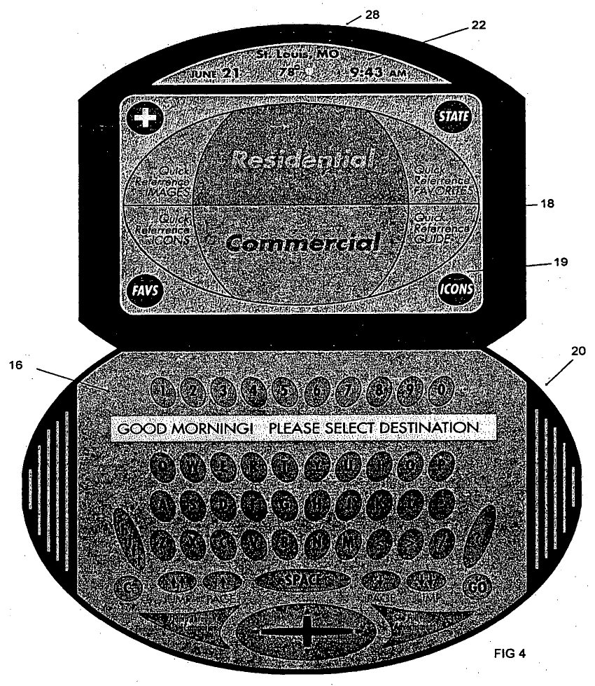

In any application involving the use of camera 28, the angle or position of camera 28 can be controlled via keys on keypad 16. For example, by pressing a ‘camera up’ key, or an “up arrow” while the device is set to control the camera, the user can cause camera 28 to swivel upward, thereby changing the viewing area of the camera. Likewise, keys may be provided to move the viewing area of the camera to the left or right or to cause the camera to zoom in and out. An embodiment of the present invention having arrow keys on keypad 16 and having camera 28 mounted in display portion 18 is provided in FIG. 4.

Virtual Environment Display

Part of the information provided with respect to a business may be a virtual walkthrough or tour of a location or product. The degree of detail provided to the user varies with the extent of the advertisement purchased by the business. For example, a restaurant may provide a virtual tour of its entire facility. Thus, a user, after pulling up a list of restaurants in the immediate area, can use keys on keypad 16 to scroll through a 360-degree image of the restaurant itself. The user can therefore see the layout, decor, size, and the like, of various restaurants prior to deciding which to patronize without having to travel to each individual location. The virtual tour of the restaurant may also include the ability to peruse a menu, updated such that daily specials can be included.

By way of another example, a nearby shopping mall might provide a virtual tour of the entire facility along with its advertisement. The user could then see not only which stores are present in the mall, but also where each is located with respect to various entrances and exits, parking lots, and the like.

With respect to products rather than facilities, a car dealer could, for example, provide photographs of various cars on its lot along with its advertisement. A user could then select a vehicle in which he is interested and take a 360-degree tour of the interior and exterior of the vehicle. Since centralized database 14 is preferably updated on a daily basis, the user is able to view automobiles that are currently present on the lot.

Regardless of the specific application of the virtual environment display, the user is able to navigate through the virtual environment using, in a preferred embodiment, interface portion 20. Keypad 16 of interface portion 20 may be provided with arrow keys or other keys suitable for navigating the virtual environment display. Pressing a particular key results in a corresponding movement of the virtual image being displayed on screen 19. For example, if a user presses a “left arrow” key, the result is that the virtual environment display scrolls to the left, revealing portions of the image that exist to the left of those previously shown on screen 19. Though keypad 16 is used for navigation in a preferred embodiment of the present invention, scrolling could also be accomplished through touch-screen method, using a stylus, or by any other suitable method for allowing the user to interface with unit 12.

In addition to the examples mentioned above, it will be clear to one skilled in the art upon reading this disclosure that many other uses of the present device as a virtual environment display may be conceived.

Travel Planning System

This aspect of the present invention provides functionality for both business travelers and vacationing users. Using the present invention as a travel planning system draws, in part, on other features of the present invention described above.

In a preferred embodiment of the present invention, centralized database 14 contains a great deal of geographical information, including atlases of inter- and intrastate highway systems, waterways, airports, hotels, landmarks, and the like. All of this information is useful with respect to the travel planning aspect of the device.

To use the travel planning features of the present invention, the user begins by selecting a travel destination. By accessing information from centralized database 14, the present device can then display directions, including a map, from the user's current location to the destination. Alternatively, rather than using his current location as a starting point, a user may find directions between any two selected points. This information may then be stored in the memory of the present device.

The features of the present device may also be used to locate airports and hotels in the area. For example, once the user has selected a destination the user may use device 12 as a mobile telephone directory to access phone numbers for hotels and airports in the vicinity. Having accessed the phone numbers, the present device may be used to place a call to any of the numbers that appear in the directory. Using earpiece 26, the user can then make hotel reservations or purchase airline tickets. In addition, if a hotel has provided a virtual tour of its facilities, the user may tour the facility using the virtual environment display features of the invention, as described above, prior to making a reservation.

Emergency GPS Locator

Because unit 12 has GPS capabilities, the device, if mobile, can be used to determine the location of a user in the event of an emergency. The use of GPS devices is known in the art and thus will not be explained in detail here. Briefly, a GPS receiver receives signals from multiple GPS satellites and triangulates these signals to determine location. In the event of an emergency, unit 12 can be used to contact authorities using a 911-calling feature. Once the appropriate authorities are contacted, the user can inform the authorities of his precise location by utilizing the GPS features of unit 12. If a user is incapacitated or cannot move, unit 12 is able to be located via the GPS satellite system as well. Thus, a third party may be able to track down the user even if the user is unable to aid in his or her own location. A button may be provided with the device to initiate a distress signal, alert monitors at centralized database 14, or dial 911 when the user is unable to complete more complicated tasks.

In addition to providing useful location-related information in emergency situations, the GPS capabilities of unit 12 can also be used to provide a user with his location in the event of an automobile breakdown, if unit 12 is a mobile unit, so that a tow-truck or repair service can be dispatched to the proper location, or in any other instance in which the user's precise location must be known.

Entertainment Directory

Though the directory features of the present invention have been described above, the present device has additional capabilities with respect to its function as an entertainment directory. Examples of the use of the present device with respect to movie and concert venues will be detailed below.

Browsing directory listings again by category, the user is able to retrieve listings for all movie theaters within a specified city or geographical area. A movie theater that is being advertised on the network of the present invention may provide virtual tours, pricing information, show times and the like directly to the user's display. In addition, the theater may also choose to provide access to movie trailers for currently released motion pictures or for upcoming motion pictures. The user can then access the trailer from unit 12 and determine from the trailer whether a particular movie appears to be interesting enough to see. Video from the movie trailer is provided to the user on screen 19, while audio is provided via earpiece 26. It is possible for the user to fast-forward or rewind the trailer using keypad 16 of interface portion 20. Alternatively, rather than providing entire movie clips for each available movie, a theater may opt to provide an advertisement that combines short clips and descriptions of each of the various movies playing at a given time. The user may navigate through the available movie selections at will, retrieving the desired clips or other information such as the cast of the film, a brief synopsis of the story line, or any other information the movie theater wishes to provide in its advertisement. As the movie listings change at a given theater, it is not necessary for the theater to produce an entirely new advertisement. The basic advertisement provided by the theater remains unchanged while specific portions of the advertisement dealing with specific movies are altered to correspond to the movies that are currently showing. This is easily accomplished because the advertisement is segregated into discreet portions, each of which can be instantly retrieved by the user while the user is navigating the advertisement.

Likewise, with respect to concert venues, a user can retrieve all such venues within a given area and view the layout of the venue, a list of upcoming shows, show times and pricing information, and even take a virtual tour of the vicinity. The present device is also able to provide directions to the venue from the user's current location or from another location identified by the user. A map may be provided to present the user with alternative routes to the venue and the map may also include a highlighted route thought to be the most efficient route from the user's location to the venue. In addition, the user may access audio or video files related to a specific musical act he/she is interested in seeing. The audio and video files are presented to the user via earpiece 26 and screen 19, respectively. By using keypad 16, in a preferred embodiment of the present invention, the user is able to fastforward or rewind the audio or video files during viewing. Further, a concert venue could provide a more interactive advertisement wherein the user uses keypad 16 (or a touch-screen or stylus in alternative embodiments of the present invention) to navigate through specific portions of the advertisement at will. A layout of the entertainment venue might also be provided, giving seating locations, numbers, availability, and the like. Again, the entertainment-related services provided are all right at the user's fingertips. There is no need to browse multiple web sites or make use of unpredictable search engines in order to find the desired information.

News Service

Another aspect of the present invention is its use as a news service. Centralized database 14 may contain the full text of various newspapers from around the world, as well as video and audio clips containing news information. The user may select a category entitled “News” using keypad 16. The user may then view news sources by category, such as “Sports,” “Business,” “International,” and the like, by country of origin of the news site, or by any other category that might be provided with the present system. Alternatively, the user may indicate in advance which news services or news stories he finds particularly interesting and schedule a news alert to be transmitted to the device when there is a new development in a particular story. For example, if the user is particularly interested in the performance of the stock market, the user may wish to receive an alert if there is a change exceeding a specified percentage in the DowJones Industrial Average. Using the news service features of the present invention, the user can be immediately informed of various news developments.

Personalized Directory

Another aspect of the present invention provides the user with a personalized directory. Using this feature of the invention, a user can categorize ‘favorites’ for even easier access and retrieval of information. The categories of “favorites” available may be displayed on screen 19 for easy selection by the user using keypad 16 or other methods of interfacing with unit 12. Examples of categories that may be provided as ‘favorites’ include “Entertainment,” “Sports,” “Din ing,” “City Attractions,” “Weekend Fun,” “Extreme Activities,” “Utilities,” “Night Life,” “Sport Activities,” “Hobbies,” “Stores” and the like. Each category designated by the user as a ‘favorite’ provide location-specific advertisements or listings for businesses or other entities related to the category of choice. As a user moves from city to city, for example, the user can easily retrieve a listing of businesses in the area associated with a particular hobby or interest. This provides an even faster method of information retrieval than searching businesses by category, as described above, because the user has in essence pre-defined the categories in which he is most interested and is therefore able to retrieve all relevant information from centralized database 14 with a simple keystroke or touch of screen 19.

With respect to any of the various applications described above, a unit constructed in accordance with the teachings of the present invention is capable of transmitting information to a home or business-based storage device 42 (as best shown in FIG. 1). Thus, for example, if the voice mail capacity of unit 12 has been reached, unit 12 can transmit the messages available in memory to storage device 42. Any other information may likewise be transmitted. Once the user returns to storage device 42, the information may be transmitted to other users, downloaded to other electronic devices, or placed on removable media such as hard disk, CD or DVD. If a user does not have a storage device 42, the user may purchase space on a centralized server, such as part of centralized database 14, and transmit information over the network to be stored on the user's purchased space.

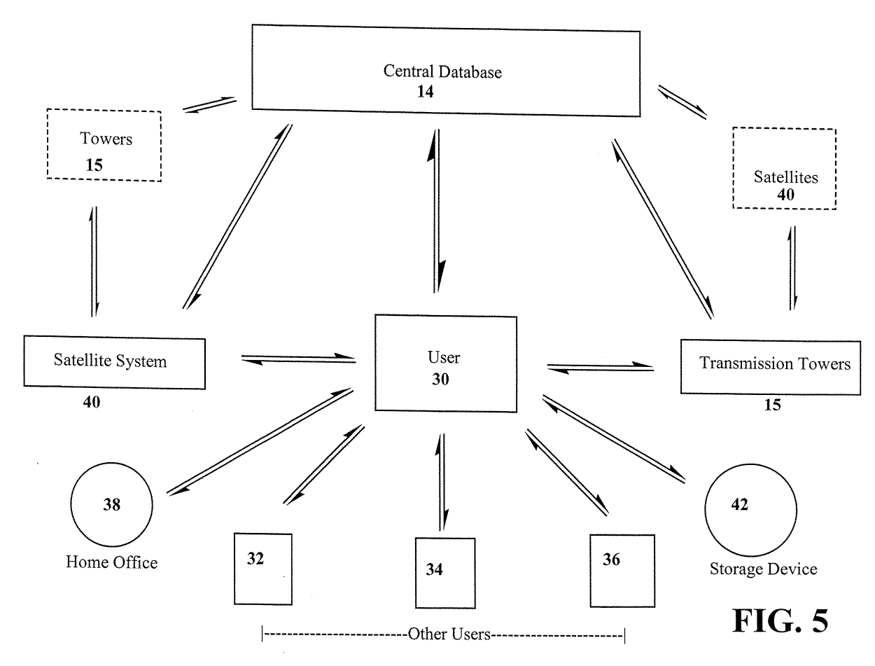

A schematic representation of the data pathways of one embodiment of the present invention is provided in FIG. 5. A user 30 in possession of a mobile unit 12 (not shown) is at the center of the figure. User 30 can communicate directly with other users 32, 34 and 36, for example, of the present system, provided that each of the users 32, 34 and 36 also have a unit 12. Likewise users 32, 34 and 36 can each communicate with one another as well as with the other components of the system. User 30 can transmit, via unit 12, data to a data storage device located at home office 38, or some other storage device 42 located elsewhere. User 20 can also retrieve information from home office 38 or some other storage device 42. Although home office 38 is used as an example in FIG. 5, user 30 may actually exchange data with any remote storage device, such as storage device 42, with which unit 12 is capable of communicating.

User 30 can communicate, via unit 12, directly with central database 14. Alternatively, user 30 may communicate with central database 14 via a satellite system 40, a transmission tower 15 (or a series thereof), or a combination of satellite system 40 and transmission towers 15.

The preceding description and examples of the present invention are meant to be illustrative and not limiting. Many additions, modifications and additional uses of the present invention will be clear to those skilled in the art upon reading this disclosure. The importance of the present invention lies in the wealth of information available to a user in a readily accessible form, controlled from a centralized database that is standardized across the system. This makes for an information network and device that is substantially more user-friendly and efficient than making use of a computer and the Internet. Many types or categories of information may be included, and many specific uses identified, while retaining the essential character of the invention. It is contemplated that one skilled in the art may identify such additions, modifications, or uses without departing from the spirit and scope of the present invention, which is limited only by the following claims.

1. A system for providing information to a mobile user comprising:
a unit capable of transmitting and receiving informational data including location positioning data, said unit further capable of displaying said data to a user and receiving commands from said user; and
a centralized database capable of transmitting and receiving data including informational and location positioning data said centralized database in electronic communication with said unit;
wherein informational data stored in said database is correlated with location positioning data received by said database from said unit, and further wherein said correlated informational data stored in said database is accessible by said user via said unit.

2. The system of claim 1 wherein said unit is in electronic communication with at least one global positioning system satellite for retrieving location positioning data.

3. The system of claim 1 further comprising signal transmission towers in electronic communication with said centralized database and said unit for transmitting said location positioning data and said correlated informational data between said centralized database and said unit.

4. The system of claim 1 wherein said unit further comprises a microphone for use in transmitting audio data through said unit and a speaker for use in receiving audio data from said unit.

5. The system of claim 1 wherein said unit further comprises a digital camera mounted therein.

6. The system of claim 1 wherein said unit further includes a display portion and an interface portion, said unit adapted such that a user can interact, via the interface portion, with a virtual environment depicted on said display portion.

7. The system of claim 1 wherein the correlated informational data transmitted from said database to said unit comprises advertising data transmitted to said unit in response to data requested by said user from said database via said unit.

8. The system of claim 2 further comprising signal transmission towers in electronic communication with said centralized database and said unit for transmitting said location positioning data and said correlated informational data between said centralized database and said unit.

9. The system of claim 2 wherein said unit further includes a display portion and an interface portion, said unit adapted such that a user can interact, via the interface portion, with a virtual environment depicted on said display portion.

10. The system of claim 2 wherein the correlated informational data transmitted from said database to said unit comprises advertising data transmitted to said unit in response to data requested by said user from said database via said unit.

11. The system of claim 3 wherein said unit further includes a display portion and an interface portion, said unit adapted such that a user can interact, via the interface portion, with a virtual environment depicted on said display portion.

12. The system of claim 3 wherein the correlated informational data transmitted from said database to said unit comprises advertising data transmitted to said unit in response to data requested by said user from said database via said unit.

13. The system of claim 4 wherein said unit further includes a display portion and an interface portion, said unit adapted such that a user can interact, via the interface portion, with a virtual environment depicted on said display portion.

14. The system of claim 4 wherein the correlated informational data transmitted from said database to said unit comprises advertising data transmitted to said unit in response to data requested by said user from said database via said unit.

15. The system of claim 5 wherein said unit further includes a display portion and an interface portion, said unit adapted such that a user can interact, via the interface portion, with a virtual environment depicted on said display portion.

16. The system of claim 5 wherein the correlated informational data transmitted from said database to said unit comprises advertising data transmitted to said unit in response to data requested by said user from said database via said unit.

17. The system of claim 6 wherein the correlated informational data transmitted from said database to said unit comprises advertising data transmitted to said unit in response to data requested by said user from said database via said unit.

18. A system for providing information to a mobile user comprising:
a unit capable of transmitting and receiving informational data including location positioning data, said unit further capable of displaying said data to a user and receiving commands from said user, said unit including a display portion for displaying data to said user and an interface portion for allowing said user to interact with said unit;
a centralized database capable of transmitting and receiving data including informational and location positioning data, said centralized database in electronic communication with said unit, wherein informational data stored in said database is correlated with location positioning data received by said database from said unit, and further wherein said correlated informational data stored in said database is accessible by said user via said unit; and
a wireless network for allowing transmission of data between said unit and said centralized database;
wherein the correlated informational data transmitted from said database to said unit comprises advertising data transmitted to said unit in response to data requested by said user from said database via said unit.

19. The system of claim 18 wherein said unit is in electronic communication with at least one global positioning system satellite for retrieving location positioning data.

20. The system of claim 18 further comprising signal transmission towers in electronic communication with said centralized database and said unit for transmitting said location positioning data and said correlated informational data between said centralized database and said unit.

21. The system of claim 18 further comprising at least one satellite in electronic communication with said centralized database and said unit for transmitting said location positioning data and said correlated informational data between said centralized database and said unit.

22. The system of claim 18 wherein said unit further comprises a microphone for use in transmitting audio data through said unit and a speaker for use in receiving audio data from said unit.

23. The system of claim 18 wherein said unit further comprises a digital camera mounted therein.

24. The system of claim 18 wherein the correlated informational data transmitted from said database to said unit further comprises news service data transmitted to said unit in response to data requested by said user from said database via said unit.

25. The system of claim 18 wherein the correlated informational data transmitted from said database to said unit further comprises travel planning data transmitted to said unit in response to data requested by said user from said database via said unit

26. The system of claim 18 wherein the correlated informational data transmitted from said database to said unit further comprises telephone directory data transmitted to said unit in response to data requested by said user from said database via said unit.

27. The system of claim 18 wherein the correlated informational data transmitted from said database to said unit further comprises digital image data transmitted to said unit in response to data requested by said user from said database via said unit.

28. The system of claim 18 wherein the correlated informational data transmitted from said database to said unit further comprises digital audio data transmitted to said unit in response to data requested by said user from said database via said unit.

29. The system of claim 19 further comprising signal transmission towers in electronic communication with said centralized database and said unit, for transmitting said location positioning data and said correlated informational data between said centralized database and said unit.

30. The system of claim 19 further comprising at least one satellite in electronic communication with said centralized database and said unit for transmitting said location positioning data and said correlated informational data between said centralized database and said unit.

31. The system of claim 19 wherein said unit further comprises a microphone for use in transmitting audio data through said unit and a speaker for use in receiving audio data from said unit.

32. The system of claim 19 wherein said unit further comprises a digital camera mounted therein.

33. The system of claim 19 wherein the correlated informational data transmitted from said database to said unit further comprises news service data transmitted to said unit in response to data requested by said user from said database via said unit.

34. The system of claim 19 wherein the correlated informational data transmitted from said database to said unit further comprises travel planning data transmitted to said unit in response to data requested by said user from said database via said unit.

35. The system of claim 19 wherein the correlated informational data transmitted from said database to said unit further comprises telephone directory data transmitted to said unit in response to data requested by said user from said database via said unit.

36. The system of claim 19 wherein the correlated informational data transmitted from said database to said unit further comprises digital image data transmitted to said unit in response to data requested by said user from said database via said unit.

37. The system of claim 19 wherein the correlated informational data transmitted from said database to said unit further comprises digital audio data transmitted to said unit in response to data requested by said user from said database via said unit.

38. The system of claim 20 further comprising at least one satellite in electronic communication with said centralized database and said unit for transmitting said location positioning data and said correlated informational data between said centralized database and said unit.

39. The system of claim 20 wherein said unit further comprises a microphone for use in transmitting audio data through said unit and a speaker for use in receiving audio data from said unit.

40. The system of claim 20 wherein said unit further comprises a digital camera mounted therein.

41. The system of claim 20 wherein the correlated informational data transmitted from said database to said unit further comprises news service data transmitted to said unit in response to data requested by said user from said database via said unit.

42. The system of claim 20 wherein the correlated informational data transmitted from said database to said unit further comprises travel planning data transmitted to said unit in response to data requested by said user from said database via said unit.

43. The system of claim 20 wherein the correlated informational data transmitted from said database to said unit further comprises telephone directory data transmitted to said unit in response to data requested by said user from said database via said unit.

44. The system of claim 20 wherein the correlated informational data transmitted from said database to said unit further comprises digital image data transmitted to said unit in response to data requested by said user from said database via said unit.

45. The system of claim 20 wherein the correlated informational data transmitted from said database to said unit further comprises digital audio data transmitted to said unit in response to data requested by said user from said database via said unit.

46. The system of claim 21 wherein said unit further comprises a microphone for use in transmitting audio data through said unit and a speaker for use in receiving audio data from said unit.

47. The system of claim 21 wherein said unit further comprises a digital camera mounted therein.

48. The system of claim 21 wherein the correlated informational data transmitted from said database to said unit further comprises news service data transmitted to said unit in response to data requested by said user from said database via said unit.

49. The system of claim 21 wherein the correlated informational data transmitted from said database to said unit further comprises travel planning data transmitted to said unit in response to data requested by said user from said database via said unit.

50. The system of claim 21 wherein the correlated informational data transmitted from said database to said unit further comprises telephone directory data transmitted to said unit in response to data requested by said user from said database via said unit.

51. The system of claim 21 wherein the correlated informational data transmitted from said database to said unit further comprises digital image data transmitted to said unit in response to data requested by said user from said database via said unit.

52. The system of claim 21 wherein the correlated informational data transmitted from said database to said unit further comprises digital audio data transmitted to said unit in response to data requested by said user from said database via said unit.

53. The system of claim 22 wherein said unit further comprises a digital camera mounted therein.

54. The system of claim 22 wherein the correlated informational data transmitted from said database to said unit further comprises news service data transmitted to said unit in response to data requested by said user from said database via said unit.

55. The system of claim 22 wherein the correlated informational data transmitted from said database to said unit further comprises travel planning data transmitted to said unit in response to data requested by said user from said database via said unit.

56. The system of claim 22 wherein the correlated informational data transmitted from said database to said unit further comprises telephone directory data transmitted to said unit in response to data requested by said user from said database via said unit.

57. The system of claim 22 wherein the correlated informational data transmitted from said database to said unit further comprises digital image data transmitted to said unit in response to data requested by said user from said database via said unit.

58. The system of claim 22 wherein the correlated informational data transmitted from said database to said unit further comprises digital audio data transmitted to said unit in response to data requested by said user from said database via said unit.

59. The system of claim 23 wherein the correlated informational data transmitted from said database to said unit further comprises news service data transmitted to said unit in response to data requested by said user from said database via said unit.

60. The system of claim 23 wherein the correlated informational data transmitted from said database to said unit further comprises travel planning data transmitted to said unit in response to data requested by said user from said database via said unit.

61. The system of claim 23 wherein the correlated informational data transmitted from said database to said unit further comprises telephone directory data transmitted to said unit in response to data requested by said user from said database via said unit.

62. The system of claim 23 wherein the correlated informational data transmitted from said database to said unit further comprises digital image data transmitted to said unit in response to data requested by said user from said database via said unit.

63. The system of claim 23 wherein the correlated informational data transmitted from said database to said unit further comprises digital audio data transmitted to said unit in response to data requested by said user from said database via said unit.

64. The system of claim 24 wherein the correlated informational data transmitted from said database to said unit further comprises travel planning data transmitted to said unit in response to data requested by said user from said database via said unit.

65. The system of claim 24 wherein the correlated informational data transmitted from said database to said unit further comprises telephone directory data transmitted to said unit in response to data requested by said user from said database via said unit.

66. The system of claim 24 wherein the correlated informational data transmitted from said database to said unit further comprises digital image data transmitted to said unit in response to data requested by said user from said database via said unit.

67. The system of claim 24 wherein the correlated informational data transmitted from said database to said unit further comprises digital audio data transmitted to said unit in response to data requested by said user from said database via said unit.

68. The system of claim 25 wherein the correlated informational data transmitted from said database to said unit further comprises telephone directory data transmitted to said unit in response to data requested by said user from said database via said unit.

69. The system of claim 25 wherein the correlated informational data transmitted from said database to said unit further comprises digital image data transmitted to said unit in response to data requested by said user from said database via said unit.

70. The system of claim 25 wherein the correlated informational data transmitted from said database to said unit further comprises digital audio data transmitted to said unit in response to data requested by said user from said database via said unit.

71. The system of claim 26 wherein the correlated informational data transmitted from said database to said unit further comprises digital image data transmitted to said unit in response to data requested by said user from said database via said unit.

72. The system of claim 26 wherein the correlated informational data transmitted from said database to said unit further comprises digital audio data transmitted to said unit in response to data requested by said user from said database via said unit.

73. The system of claim 27 wherein the correlated informational data transmitted from said database to said unit further comprises digital audio data transmitted to said unit in response to data requested by said user from said database via said unit.

74. A system for providing information to a mobile user comprising:
a unit capable of transmitting and receiving informational data including location positioning data, said unit further capable of displaying said data to a user and receiving commands from said user, said unit including a display portion for displaying data to said user and an interface portion for allowing said user to interact with said unit;
a centralized database capable of transmitting and receiving data including informational and position location positioning data, said centralized database in electronic communication with said unit, wherein information data stored in said database is correlated with location positioning data received by said database from said unit, and further wherein said correlated informational data stored in said database is accessible by said user via said unit;
a wireless network for allowing transmission of said location positioning data and said correlated informational data between said unit and said centralized database;
a microphone in electronic communication with said unit for transmitting audio data to said unit;
a speaker in electronic communication with said unit for receiving audio information from said unit;
a digital camera mounted in said unit;
wherein said unit is operable to allow a user to interact with a virtual environment via said interface portion of said unit; and
and further wherein said correlated informational data transmitted between said centralized database and said unit is selected from the group consisting of advertising data transmitted, telephone directory data, travel planning data, news service data, digital image data, and digital audio data, and wherein said correlated informational data is transmitted to said unit in response to data requested by said user from said database via said unit.

75. The device of claim 1 wherein said unit is a mobile unit.

76. The system of claim 1 wherein said unit is a stationary unit.

77. The system of claim 18 wherein said unit is a mobile unit.

78. The system of claim 18 wherein said unit is a stationary unit.

79. The system of claim 74 wherein said unit is a mobile unit.

80. The system of claim 74 wherein said unit is a stationary unit.

81. The system of claim 1 wherein said user can transmit data from said unit to a remote data storage device for storage therein.

82. The system of claim 18 wherein said user can transmit data from said unit to a remote data storage device for storage therein.

83. The system of claim 74 wherein said user can transmit data from said unit to a remote data storage device for storage therein.
